(19) United States
(12) Patent Application Publication
(10) Pub. No.: US 2025/0357778 A1
(43) Pub. Date: Nov. 20, 2025

(54) STORAGE BATTERY CONTROL DEVICE, ELECTRICITY STORAGE SYSTEM, AND STORAGE BATTERY CONTROL METHOD

(71) Applicant: YAZAKI CORPORATION, Tokyo (JP)

(72) Inventor: Takahiro Syouda, Susono-shi (JP)

(21) Appl. No.: 19/290,361

(22) Filed: Aug. 5, 2025

Related U.S. Application Data
(63) Continuation of application No. PCT/JP2024/004657, filed on Feb. 9, 2024.

(30) Foreign Application Priority Data
Mar. 13, 2023 (JP) 2023-038380

(51) Int. Cl. H02J 7/00

(52) U.S. Cl. CPC H02J 7/007182; H02J 7/0013; H02J 7/00308; H02J 2207/20

(57) ABSTRACT

A storage battery control device sets a string current to a first predetermined value by a power converter and sets a connection or bypass state of the storage battery modules to a predetermined state by the bypass switch units such that a total voltage of a storage battery string is equal to or less than a withstand voltage of the bypass switch units and a first condition under which arc discharge occurs in switches, which are mechanical relays, is satisfied, and executes oxide film removal processing to open and close the switches, which are mechanical relays, in a state that the first condition is satisfied.

### CROSS-REFERENCE TO RELATED APPLICATIONS

This is a continuation of International Application No. PCT/JP2024/004657 filed on Feb. 9, 2024, and claims priority from Japanese Patent Application No. 2023-038380 filed on Mar. 13, 2023, the entire content of which is incorporated herein by reference.

### TECHNICAL FIELD

The present disclosure relates to a storage battery control device, an electricity storage system, and a storage battery control method.

### BACKGROUND ART

An electricity storage system in which a storage battery string includes a plurality of storage batteries connected in series and bypass circuits each provided for each of the storage batteries and switching the corresponding storage battery between a connected state and a bypass state is known (for example, see Patent Literature 1). In the electricity storage system described in Patent Literature 1, bypass control is executed to bypass a storage battery that cannot discharge a required current, and discharging is performed from another storage battery.

### CITATION LIST

### Patent Literature

Patent Literature 1: JP2013-031247A

### SUMMARY OF INVENTION

In the electricity storage system described in Patent Literature 1, it is necessary to prevent a large fluctuation from occurring in input and output power of the electricity storage system during the execution of the bypass control. Further, in the electricity storage system described in Patent Literature 1, since a total voltage of the storage battery string is applied to a switch of the bypass circuit when the bypass control is executed, it is necessary to use a switch having a high withstand voltage or provide a protection circuit for a switch. When the protection circuit for a switch is provided, it is necessary to prevent a voltage exceeding the withstand voltage from being applied to the protection circuit. As a method for solving these problems, a method of executing bypass control after reducing a current of a storage battery string (hereinafter, referred to as a string current) by a power converter is considered.

However, when a mechanical relay is used as the switch of the bypass circuit, if a switching operation of opening and closing the switch is executed after the string current is reduced, there is a possibility that arc discharge does not occur in a contact portion of the mechanical relay. Since an oxide film is formed on the contact portion of the mechanical relay over time, when the arc discharge does not occur in the contact portion, the oxide film formed on the contact portion is not removed, and contact failure may occur in the contact portion.

In view of the above circumstances, an object of the present disclosure is to provide a storage battery control device, an electricity storage system, and a storage battery control method capable of suppressing a fluctuation in input and output power of the system and removing oxide films from contact portions of mechanical relays of bypass circuits in the electricity storage system in which a storage battery string includes a plurality of storage batteries connected in series and the plurality of bypass circuits each provided for each of the storage batteries and switching the corresponding storage battery between a connected state and a bypass state.

A storage battery control device according to an embodiment is a storage battery control device that controls an electricity storage system including a storage battery string and a power converter that converts input and output power of the storage battery string, in which the storage battery string includes a plurality of storage batteries connected in series, and a plurality of bypass circuits each including a first switch that is provided between the storage batteries adjacent to each other, a bypass line that bypasses the first switch and the storage battery, and a second switch that is provided on the bypass line, and switching the storage battery between a connected state and a bypass state, at least one of the first switch and the second switch is a mechanical relay, a current of the storage battery string is set to a first predetermined value by the power converter, and a connection or bypass state of the plurality of storage batteries is set to a predetermined state by the plurality of bypass circuits such that a total voltage of the storage battery string is equal to or less than a withstand voltage of the bypass circuit and a first condition under which arc discharge occurs in the at least one of the first switch and the second switch, which are mechanical relays, is satisfied, and oxide film removal processing of opening and closing the at least one of the first switch and the second switch, which are mechanical relays, is executed in a state in which the first condition is satisfied.

An electricity storage system according to an embodiment is an electricity storage system including: a storage battery string; a power converter configured to convert input and output power of the storage battery string; and a storage battery control device configured to control the storage battery string and the power converter, in which the storage battery string includes a plurality of storage batteries connected in series, and a plurality of bypass circuits each including a first switch that is provided between the storage batteries adjacent to each other, a bypass line that bypasses the first switch and the storage battery, and a second switch that is provided on the bypass line, and switching the storage battery between a connected state and a bypass state, at least one of the first switch and the second switch is a mechanical relay, and the storage battery control device sets a current of the storage battery string to a first predetermined value by the power converter and sets a connection or bypass state of the plurality of storage batteries to a predetermined state by the plurality of bypass circuits such that a total voltage of the storage battery string is equal to or less than a withstand voltage of the bypass circuit and a first condition under which arc discharge occurs in the at least one of the first switch and the second switch, which are mechanical relays, is satisfied, and executes oxide film removal processing of opening and closing the at least one of the first switch and the second switch, which are mechanical relays, in a state in which the first condition is satisfied.

An electricity storage system according to an embodiment is an electricity storage system including: a storage battery string; a power converter configured to convert input and output power of the storage battery string; and a storage battery control device configured to control the storage battery string and the power converter, in which the storage battery string includes a plurality of storage batteries connected in series, a plurality of bypass circuits each including a first switch that is a mechanical relay and is provided between the storage batteries adjacent to each other, a bypass line that bypasses the first switch and the storage battery, and a second switch that is provided on the bypass line, and switching the storage battery between a connected state and a bypass state, and a power storage and current suppression circuit connected between the first switch corresponding to the storage battery at a beginning and the power converter, and between the storage battery at an end and the power converter, and including a power storage unit and a current suppression unit, and the storage battery control device executes first oxide film removal processing of switching any one of the storage batteries to a connected state by any one of the bypass circuits after all the storage batteries are set to the bypass state by the plurality of bypass circuits, and sets a maximum value of a transient current flowing through the storage battery in the connected state, the first switch, and the power storage and current suppression circuit such that a total voltage of the storage battery string is equal to or less than a withstand voltage of the bypass circuit and a first condition under which arc discharge occurs in the first switch is satisfied when the storage battery control device executes the first oxide film removal processing.

A storage battery control method according to an embodiment is a storage battery control method executed by a storage battery control device that controls an electricity storage system including a storage battery string and a power converter that converts input and output power of the storage battery string, the storage battery string including a plurality of storage batteries connected in series, and a plurality of bypass circuits each including a first switch that is provided between the storage batteries adjacent to each other, a bypass line that bypasses the first switch and the storage battery, and a second switch that is provided on the bypass line, and switching the storage battery between a connected state and a bypass state, and at least one of the first switch and the second switch being a mechanical relay, the method including: setting a current of the storage battery string to a first predetermined value by the power converter and setting a connection or bypass state of the plurality of storage batteries to a predetermined state by the plurality of bypass circuits such that a total voltage of the storage battery string is equal to or less than a withstand voltage of the bypass circuit and a first condition under which arc discharge occurs in the at least one of the first switch and the second switch, which are mechanical relays, is satisfied; and executing oxide film removal processing of opening and closing the at least one of the first switch and the second switch, which are mechanical relays, in a state in which the first condition is satisfied.

According to the present disclosure, in the electricity storage system in which the storage battery string includes the plurality of storage batteries connected in series and the plurality of bypass circuits each provided for each of the storage batteries and switching the corresponding storage battery between the connected state and the bypass state, it is possible to suppress fluctuation in the input and output power of the system and remove the oxide films from contact portions of the mechanical relays of the bypass circuits.

### BRIEF DESCRIPTION OF DRAWINGS

FIG. 1 is a circuit diagram schematically illustrating an electricity storage system including a storage battery control device according to an embodiment of the present disclosure;

FIG. 2 is a flowchart illustrating processing of switching a storage battery module that is a target of a bypass control request from a connected state to a bypass state;

FIG. 3 is a flowchart illustrating oxide film removal processing according to another embodiment of the present disclosure;

FIG. 4 is a circuit diagram schematically illustrating an electricity storage system according to another embodiment of the present disclosure; and

FIG. 5 is a flowchart illustrating processing in which the storage battery control device illustrated in FIG. 4 switches the storage battery module that is a target of the bypass control request from the connected state to the bypass state.

### DESCRIPTION OF EMBODIMENTS

Hereinafter, the present disclosure will be described with reference to preferred embodiments. The present disclosure is not limited to the embodiment to be described below, and the embodiment can be appropriately modified without departing from the gist of the present disclosure. In the embodiments to be described below, a part of configurations may be not described or illustrated in the drawings, and regarding details of the omitted techniques, publicly known or well-known techniques will be appropriately applied as long as there is no contradiction with the contents to be described below.

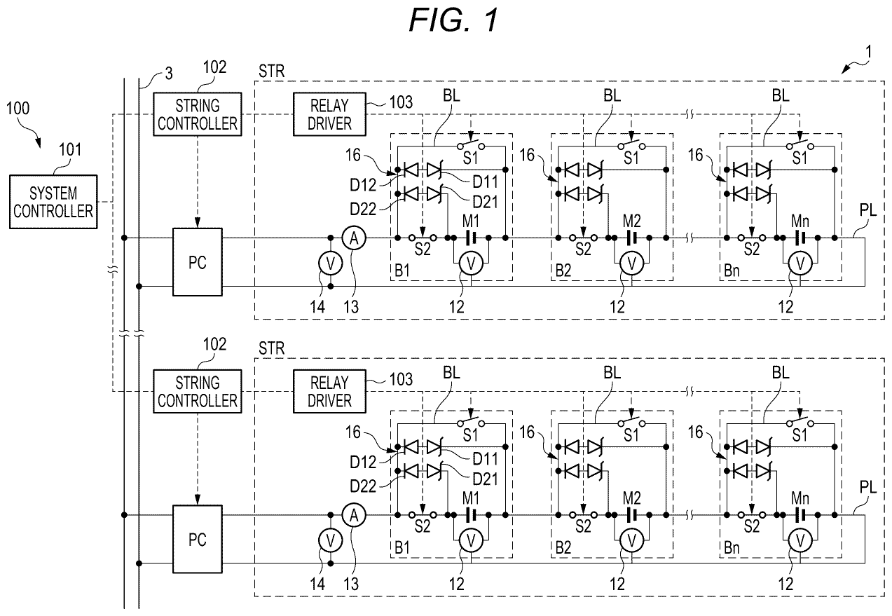

FIG. 1 is a circuit diagram schematically illustrating an electricity storage system 1 including a storage battery control device 100 according to an embodiment of the present disclosure. As illustrated in FIG. 1, the electricity storage system 1 includes a plurality of storage battery strings STR, a plurality of power converters PC, a string bus 3, and a storage battery control device 100. The plurality of storage battery strings STR are connected in parallel to each other via the string bus 3 and are connected to an external system (not illustrated). The 20 electricity storage system 1 is a stationary or in-vehicle power supply.

The storage battery string STR includes n (n being an integer of 2 or more) storage battery modules M1 to Mn connected in series. Although not particularly limited, the storage battery modules M1 to Mn of the present embodiment are obtained by regenerating used storage batteries, and there is a difference in deterioration levels of the storage battery modules M1 to Mn. The storage battery modules M1 to Mn are formed by connecting a plurality of secondary battery cells such as lithium ion batteries and lithium ion capacitors.

The storage battery modules M1 to Mn are charged with power supplied from the external system through the string bus 3 and the power converter PC. The storage battery modules M1 to Mn supply power to the external system through the power converter PC and the string bus 3.

The external system includes a load, a power generator, and the like. When the electricity storage system 1 is a stationary power supply, home appliances, a commercial power supply system, and the like serve as loads, and a solar photovoltaic power generation system and the like serves as a power generator. On the other hand, when the electricity storage system 1 is an in-vehicle power supply, a driving motor, an air conditioner, various in-vehicle electrical components, and the like serve as loads. The driving motor serves as the load and also as the generator.

The storage battery string STR may include n storage battery cells or storage battery packs connected in series instead of the n storage battery modules M1 to Mn connected in series. Further, the storage battery string STR may include bypass circuits each of which bypasses each storage battery cell or each storage battery pack.

The power converter PC is a DC/DC converter or a DC/AC converter, and is connected to the string bus 3. The power converter PC is connected to a positive electrode of the storage battery module M1 at a beginning and a negative electrode of the storage battery module Mn at an end.

When the storage battery string STR is charged, the power converter PC converts a voltage received from the string bus 3 according to an instruction value of charging power (or a current) to be described later and outputs the converted voltage to the plurality of storage battery modules M1 to Mn. Here, a voltage on a side of the storage battery string STR changes according to a bypass state (the number of bypassed storage battery modules M1 to Mn) of the storage battery modules M1 to Mn and a charge state of the storage battery modules M1 to Mn. Therefore, when the storage battery string STR is charged, the power converter PC converts the voltage received from the string bus 3 into the voltage on the side of the storage battery string STR and outputs the converted voltage to the plurality of storage battery modules M1 to Mn.

When the storage battery string STR is discharged, the power converter PC converts a voltage received from the plurality of storage battery modules M1 to Mn according to an instruction value of a discharging power (or current) to be described later and outputs the converted voltage to the string bus 3. Here, the voltage input to the power converter PC during discharge changes according to a bypass state of the storage battery modules M1 to Mn and a charge state of the storage battery modules M1 to Mn. Accordingly, voltages input to the power converters PC vary between the storage battery strings STR during discharge. Therefore, when the storage battery strings STR are discharged, each of the power converters PC converts the input voltage into a voltage matching the other storage battery string STR and outputs the converted voltage to the string bus 3.

The power converter PC is a bidirectional converter. When the current flowing through the string bus 3 is an alternating current, the power converter PC includes a synchronization unit for following a change in an instantaneous value.

Each of the storage battery strings STR includes n bypass switch units B1 to Bn, n voltage sensors 12, one current sensor 13, one voltage sensor 14, n temperature sensors (not illustrated), and a large number of cell voltage sensors (not illustrated).

The voltage sensor 12 is connected between positive and negative electrode terminals of each of the storage battery modules M1 to Mn, detects a voltage between the terminals of each of the storage battery modules M1 to Mn, and transmits a detection signal to each of string controllers 102 to be described later. The current sensor 13 is provided on a power line PL of the storage battery string STR, detects a string current, and transmits a detection signal to the string controller 102. The voltage sensor 14 is provided on the power line PL of the storage battery string STR, detects a total voltage of the storage battery string STR, and transmits a detection signal to the string controller 102.

A temperature sensor is provided for each of the storage battery modules M1 to Mn, detects a temperature of each of the storage battery modules M1 to Mn, and transmits a detection signal to the string controller 102. Further, a cell voltage sensor is provided for each storage battery cell (not shown) of each of the storage battery modules M1 to Mn, detects a voltage of the storage battery cell, and transmits a detection signal to the string controller 102.

The bypass switch units B1 to Bn are provided for the storage battery modules M1 to Mn, respectively. Each of the bypass switch units B1 to Bn includes a bypass line BL, switches S1 and S2, and a protection circuit 16. The bypass line BL is a power line that bypasses each of the storage battery modules M1 to Mn and the switch S2. The switch S1 is provided on the bypass line BL. The switch S1 is a mechanical relay. The switch S2 is provided between a positive electrode of each of the storage battery modules M1 to Mn and one end of the bypass line BL. The switch S2 is a mechanical relay.

The storage battery module M1 at the beginning and the storage battery module Mn at the end are connected to the external system via the power converter PC and the string bus 3. When the switch S1 is open and the switch S2 is closed in all the bypass switch units B1 to Bn, all the storage battery modules M1 to Mn are connected in series to the external system. On the other hand, when the switch S2 is open and the switch S1 is closed in any one of the bypass switch units B1 to Bn, the storage battery modules M1 to Mn corresponding to the bypass switch units B1 to Bn are bypassed.

The protection circuit 16 includes a Zener diode D11 and a diode D12 connected in parallel with the switch S1, and a Zener diode D21 and a diode D22 connected in parallel with the switch S2, and performs overvoltage protection of the switches S1 and S2. An anode of the Zener diode D11 is connected to an anode of the diode D12. An anode of the Zener diode D21 is connected to an anode of the diode D22.

A cathode of the Zener diode D11 is connected to the bypass line BL between the switch S1 and a negative electrode of one of the storage battery modules M1 to Mn. On the other hand, a cathode of the diode D12 is connected to the bypass line BL between the switch S1 and the switch S2.

A cathode of the Zener diode D21 is connected to the power line PL between the switch S2 and the positive electrode of one of the storage battery modules M1 to Mn. On the other hand, a cathode of the diode D22 is connected to the bypass line BL between the switch S1 and the switch S2.

Here, when the protection circuit 16 is not provided, the voltage applied to both ends of a contact of the switch S2 when the switch S2 is off is a total voltage of the storage battery modules M1 to Mn in the connected state and the storage battery modules M1 to Mn corresponding to the switch S2. In this case, a withstand voltage of the switch S2 needs to be equal to or higher than the total voltage of the n storage battery modules M1 to Mn (the voltage of the storage battery string STR when all the storage battery modules M1 to Mn are in the connected state). On the other hand, when the protection circuit 16 is provided, the voltage applied to both ends of the contact of the switch S2 when the switch S2 is off becomes the Zener voltage of the Zener diode D21. In this case, the withstand voltage of the switch S2 may be equal to or higher than the Zener voltage of the Zener diode D21. From the viewpoint of suppressing the loss generated in the protection circuit 16 to an allowable loss or less, input and output power is reduced by the power converter PC, and a large current is prevented from flowing into the protection circuit 16.

When the protection circuit 16 is not provided, the voltage applied to both ends of a contact of the switch S1 when the switch S1 is off is the total voltage of the storage battery modules M1 to Mn in the connected state. In this case, a withstand voltage of the switch S1 needs to be equal to or higher than a total voltage of the (n−1) storage battery modules M1 to Mn (the voltage of the storage battery string STR when all the storage battery modules M1 to Mn except for one are in the connected state). On the other hand, when the protection circuit 16 is provided, the voltage applied to both ends of the contact of the switch S1 when the switch S1 is off becomes the Zener voltage of the Zener diode D11. In this case, the withstand voltage of the switch S1 may be equal to or higher than the Zener voltage of the Zener diode D11. The protection circuit 16 includes two sets of the Zener diode D11 and the diode D12 connected in parallel with the switch S1 and the Zener diode D21 and the diode D22 connected in parallel with the switch S2, but may include any one set. In this case, the voltage applied to the switch S2 is the sum of voltages of the adjacent storage battery modules M1 to Mn. Therefore, the withstand voltage of the contact of the switch S2 needs to be higher than the sum of the Zener voltage and the voltages of the storage battery modules M1 to Mn.

The storage battery control device 100 includes a plurality of string controllers 102, a plurality of relay drivers 103, and one system controller 101. The string controller 102 and the relay driver 103 are provided for each of the storage battery strings STR.

The string controller 102 transmits a control signal to the relay driver 103 of the corresponding storage battery string STR and the power converter PC. The relay driver 103 controls the switches S1 and S2 of the corresponding bypass switch units B1 to Bn according to the control signal transmitted from the corresponding string controller 102. The power converter PC converts charging and discharging power of the corresponding storage battery string STR according to the control signal transmitted from the corresponding string controller 102. Further, the power converter PC controls the string current of the corresponding storage battery string STR according to the control signal from the corresponding string controller 102.

The string controller 102 executes detection and estimation of a state of the corresponding storage battery string STR, notification of a device control request to the system controller 101, and the like. Examples of detection of the state of the storage battery string STR include detection of the string current of the storage battery string STR based on the detection signal of the corresponding current sensor 13, detection of the total voltage of the storage battery string STR based on the detection signal of the corresponding voltage sensor 14, detection of the voltages of the storage battery modules M1 to Mn based on detection signals of the voltage sensors 12, detection of temperatures of the storage battery modules M1 to Mn based on the detection signals from the temperature sensors, and detection of voltages of the storage battery cells based on the detection signals of the cell voltage sensors. Examples of estimation of the state of the storage battery string STR include estimation of states of charge (SOCs) and states of health (SOHs) of the storage battery modules M1 to Mn, and estimation of SOCs and SOHs of the storage battery string STR. Further, examples of the notification of the device control request to the system controller 101 include a switch control request for opening and closing the switches S1 and S2 of the bypass switch units B1 to Bn, a request for control of the power converter PC, and the like.

Examples of a method for estimating the SOH include a method based on a charge and discharge test, a method based on a current integration method, a method based on measurement of an open circuit voltage, a method based on measurement of a terminal voltage, a method based on a model (the above is a method using a temporal change in SOC), a method based on AC impedance measurement, an obtaining method using an adaptive digital filter based on a model, a method by linear regression (an inclination of a straight line of I-V characteristics) based on I-V characteristics (current-voltage characteristics), and a method based on a step response (the above is a method for estimating using a temporal increase in internal resistance).

Examples of a method for estimating the SOC include various known methods such as a current integration method, an obtaining method (voltage method) based on an open circuit voltage (OCV), and a method combining the current integration method and the voltage method. The OCV can be estimated using various known estimation methods using a temporal change in terminal voltage or a temporal increase in internal resistance. The system controller 101 is a controller that integrally controls the entire electricity storage system 1, and executes 1: m communication with the plurality of string controllers 102. The system controller 101 monitors the states of the storage battery strings STR, determines whether to permit the device control requests from the string controllers 102, and notifies the string controllers 102 of permission for the device control requests. The system controller 101 sets the instruction value of the charging and discharging power (or current) of each of the storage battery strings STR, and transmits the instruction value of the charging and discharging power (or current) to the string controller 102.

The system controller 101 monitors the state of the storage battery string STR based on detection results and estimation results of the state of the storage battery string STR transmitted from the string controller 102. Then, the system controller 101 calculates the instruction value of the charging and discharging power (or current) to be allocated to each of the storage battery string STR according to the instruction of the input and output power (or current) of the entire electricity storage system 1 received from an upper system (not illustrated) and the state of the storage battery string STR.

Here, when the switch control request (hereinafter, referred to as a bypass control request) for opening and closing the switches S1 and S2 of the bypass switch units B1 to Bn (hereinafter, B′) for any of the storage battery modules M1 to Mn (hereinafter, M′) is permitted by the system controller 101, each string controller 102 executes the switching control of opening and closing the switches S1 and S2 of the bypass switch unit B′. At this time, the string controller 102 executes protection and oxide film removal processing to protect the protection circuit 16 and remove an oxide film formed on contact portions of the switches S1 and S2 before executing the switching control of opening and closing the switches S1 and S2 of the bypass switch unit B′.

The protection and oxide film removal processing includes string current reducing processing, bypass state switching processing, string current increase processing, and oxide film removal processing. The string current reducing processing is processing of reducing the string current to a second predetermined value. The second predetermined value is a value lower than a first predetermined value to be described later, and is set to a low value to the extent that the fluctuation in the input and output power of the entire electricity storage system 1 is suppressed within an allowable range during a bypass control of the storage battery string STR. In the present embodiment, the second predetermined value is 0, and a “second condition” is satisfied when the string current is 0.

Here, in the string current reducing processing, the string controller 102 gradually and continuously reduces the instruction value of the string current from the current value to the second predetermined value. Specifically, the string controller 102 repeatedly updates the instruction value of the string current by a predetermined amount ΔP1 obtained by equally dividing a difference between the current value of the instruction value of the string current and the second predetermined value. At this time, a change rate (amount of change per time) of the instruction value of the string current is set to the extent that the fluctuation in the input and output power of the entire electricity storage system 1 is suppressed within the allowable range. Accordingly, the power converter PC gradually and continuously reduces the instruction value of the string current from the current value to the second predetermined value to suppress the fluctuation in the input and output power of the entire electricity storage system 1 within the allowable range.

The bypass state switching processing is processing of switching the states of the switches S1 and S2 of the bypass switch units B1 to Bn (hereinafter, B″) corresponding to the storage battery modules M1 to Mn (hereinafter, M″) that are not targets of the bypass control request. In the bypass state switching processing, the string controller 102 determines the connection or bypass state (“predetermined state”) of the plurality of storage battery modules M″ such that a “first condition” of the storage battery string STR is satisfied. The “first condition” is a condition under which the total voltage of the storage battery string STR is equal to or less than a withstand voltage of the protection circuit 16 and arc discharge occurs in the switches S1 and S2, which are the mechanical relays. That is, the string controller 102 determines the connection or bypass state of the plurality of storage battery modules M″ such that the total voltage of the storage battery string STR is equal to or lower than the withstand voltage of the protection circuit 16 when the oxide film removal processing is executed. Further, the string controller 102 sets the string current to the “first predetermined value” in the string current increase processing to be described later such that the arc discharge occurs in the switches S1 and S2 when the oxide film removal processing is executed. Note that the storage battery modules M″ to be connected are selected according to a priority order determined based on a predetermined criterion. Here, in a discharge mode, at least one of the storage battery modules M″ that are not targets of the bypass control request is set to the connected state.

The string current increase processing is processing of increasing the string current from the second predetermined value to the first predetermined value. The first predetermined value is set to a value at which arc discharge occurs in the contact portions of the switches S1 and S2 during the operation of the switches S1 and S2, which are the mechanical relays, and an oxide film formed at the contact portions can be removed.

Here, in the string current increase processing, the string controller 102 gradually and continuously increases the instruction value of the string current from the current value (second predetermined value) to the first predetermined value. Specifically, the string controller 102 repeatedly updates the instruction value of the string current by a predetermined amount ΔP2 obtained by equally dividing a difference between the current value of the instruction value of the string current and the first predetermined value. At this time, the change rate of the instruction value of the string current is set to the extent that the fluctuation in the input and output power of the entire electricity storage system 1 is suppressed within the allowable range. Accordingly, the power converter PC gradually and continuously increases the instruction value of the string current from the current value to the first predetermined value to suppress the fluctuation in the input and output power of the entire electricity storage system 1 within the allowable range.

The oxide film removal processing is processing in which, in a state in which the first condition is satisfied, the arc discharge occurs in the contact portions of the switches S1 and S2 of the bypass switch unit B′ to remove the oxide film formed at the contact portions. Specifically, the string controller 102 switches the switch S2 from close to open, then from open to close, and further from close to open in a state in which the string current of the first predetermined value flows through the switch S2 of the bypass switch unit B′. Further, the string controller 102 switches the switch S1 from close to open, then from open to close, and further from close to open in a state in which the string current of the first predetermined value flows through the switch S1 of the bypass switch unit B′.

The string controller 102 records the connection or bypass state of the storage battery modules M1 to Mn of the storage battery string STR at a present time point in a built-in memory (not illustrated) before the protection and oxide film removal processing is executed. After executing the protection and oxide film removal processing, the string controller 102 switches the open/close state of the switches S1 and S2 of the bypass switch unit B″ to restore the connection or bypass state of the storage battery module M″ that is not the target of the bypass control request to the state recorded in the memory. At this time, the string controller 102 switches the open/close state of the switches S1 and S2 of the bypass switch unit B′ such that the storage battery module M′ that is a target of the bypass control request is in the bypass state.

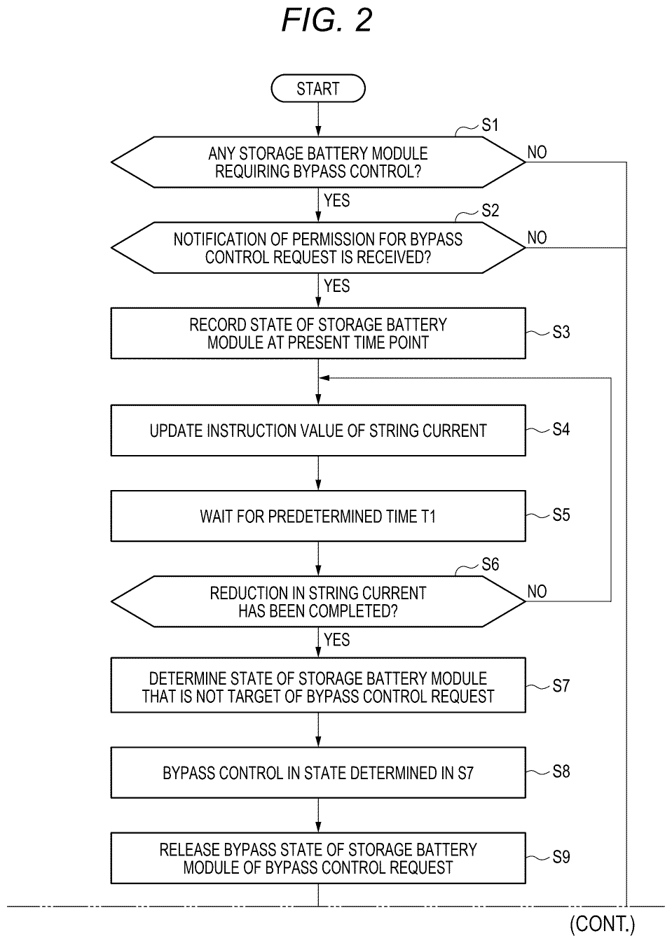

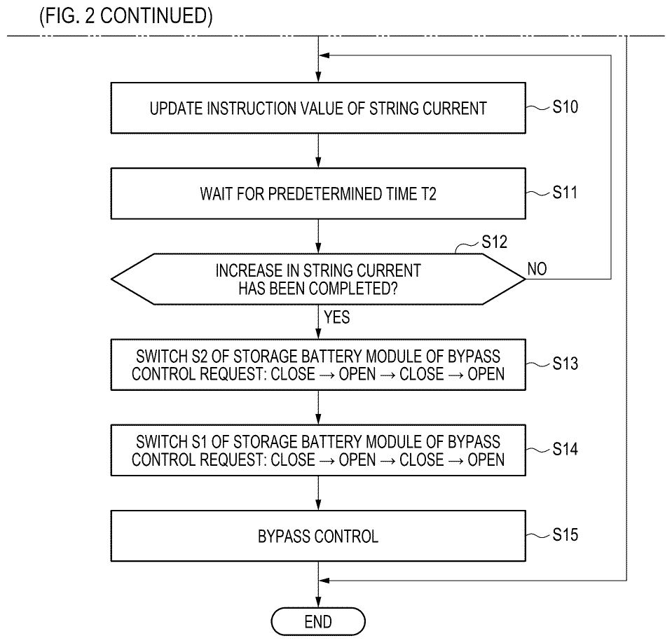

FIG. 2 is a flowchart illustrating processing of switching the storage battery module M′ that is a target of the bypass control request from the connected state to the bypass state (bypass control). First, in step S1, the string controller 102 monitors the storage battery modules M1 to Mn of the storage battery string STR, and determines whether there are storage battery modules M1 to Mn requiring the bypass control. If the determination is yes in step S1, the processing proceeds to step S2, and if the determination is no in step S1, the processing ends.

In step S2, the string controller 102 transmits the bypass control request to the system controller 101, and determines whether a notification of permission for the bypass control request is received from the system controller 101. If the determination is yes in step S2, the processing proceeds to step S3, and if the determination is no in step S2, the processing ends.

In step S3, the string controller 102 records the connection or bypass state of the storage battery modules M1 to Mn of the storage battery string STR at the present time point in the built-in memory (not illustrated). Next, the string controller 102 repeatedly executes loop processing of steps S4 to S6 until the instruction value of the string current reaches the second predetermined value (string current reducing processing). Here, in steps S4 to S6, the string controller 102 gradually and continuously reduces the instruction value of the string current from the current value to the second predetermined value by the predetermined amount ΔP1.

First, in step S4, the string controller 102 updates the instruction value of the string current to a value reduced by the predetermined amount ΔP1. The predetermined amount ΔP1 is set to a small amount to meet the purpose of preventing a sudden change in the input and output power of the electricity storage system 1. When the difference between the current value of the string current and the second predetermined value is small, the predetermined amount ΔP1 may be equal to the difference between the current value of the string current and the second predetermined value. On the other hand, when the difference between the current value of the string current and the second predetermined value is relatively large, the predetermined amount ΔP1 may be smaller than the difference between the current value of the string current and the second predetermined value. When the predetermined amount ΔP1 is smaller than the difference between the current value of the string current and the second predetermined value, the string current is repeatedly updated a plurality of times.

Next, in step S5, the string controller 102 waits for a predetermined time T1 after transmitting the instruction value of the string current to the power converter PC. The predetermined time T1 is set in consideration of time required for the string controller 102 to control the power converter PC and the change rate of the string current.

Next, in step S6, the string controller 102 determines whether the string current has reached the second predetermined value (whether the reduction in the string current has been completed). If the determination is yes in step S6, the processing proceeds to step S7, and if the determination is no in step S6, the processing proceeds to step S4.

In steps S7 and S8, the string controller 102 executes the bypass state switching processing. First, in step S7, the string controller 102 determines the connection or the bypass state of the storage battery modules M″ that are not targets of the bypass control request. In step S7, the storage battery module M″ to be set to the connected state and the storage battery module M″ to be set to the bypass state are determined such that the total voltage of the storage battery string STR is equal to or lower than the withstand voltage of the protection circuit 16 when the string current of the first predetermined value flows.

Next, in step S8, the string controller 102 switches open/close of the switches S1 and S2 of the bypass switch units B″ such that the connection or bypass state of the storage battery modules M″ that are not targets of the bypass control request is switched to the state determined in step S7. Next, in step S9, the string controller 102 switches open/close of the switches S1 and S2 of the bypass switch unit B′ such that the storage battery module M′ that is a target of the bypass control request is in the connected state.

Next, the string controller 102 repeatedly executes the loop processing of steps S10 to S12 until the instruction value of the string current reaches the first predetermined value (string current increase processing). Here, in steps S10 to S12, the string controller 102 gradually and continuously increases the instruction value of the string current from the current value to the first predetermined value by the predetermined amount ΔP2.

First, in step S10, the string controller 102 updates the instruction value of the string current to a value increased by the predetermined amount ΔP2. The predetermined amount ΔP2 is set to a small amount to meet the purpose of preventing a sudden change in the input and output power of the electricity storage system 1. When the difference between the current value of the string current and the first predetermined value is small, the predetermined amount ΔP2 may be equal to the difference between the current value of the string current and the first predetermined value. On the other hand, when the difference between the current value of the string current and the first predetermined value is relatively large, the predetermined amount ΔP2 may be smaller than the difference between the current value of the string current and the first predetermined value. When the predetermined amount ΔP2 is smaller than the difference between the current value of the string current and the first predetermined value, the string current is repeatedly updated a plurality of times.

Next, in step S11, the string controller 102 waits for a predetermined time T2 after transmitting the instruction value of the string current to the power converter PC. The predetermined time T2 is set in consideration of time required for the string controller 102 to control the power converter PC and the change rate of the string current.

Next, in step S12, the string controller 102 determines whether the instruction value of the string current has reached the first predetermined value (whether the increase in the string current has been completed). If the determination is yes in step S12, the processing proceeds to step S13, and if the determination is no in step S12, the processing proceeds to step S10.

In steps S13 and S14, the string controller 102 executes the oxide film removal processing. First, in step S13, the string controller 102 switches the switch S2 from close to open in a state in which the string current of the first predetermined value flows through the switch S2 of the bypass switch unit B′ (S13-1 in Table 1 below). Then, the string controller 102 switches the switch S2 from open to close (S13-2 in Table 1 below) and then from close to open (S13-3 in Table 1 below). Accordingly, arc discharge occurs in the contact portion of the switch S2, and the oxide film formed at the contact portion is removed.

Next, in step S14, the string controller 102 switches the switch S1 of the bypass switch unit B′ from open to close to cause the string current of the first predetermined value to flow to the switch S1 of the bypass switch unit B′ (S14-1 in Table 1 below). Then, the string controller 102 switches the switch S1 of the bypass switch unit B′ from close to open (S14-2 in Table 1 below), then from open to close (S14-3 in Table 1 below), and further from close to open (S14-4 in Table 1 below). Accordingly, the arc discharge occurs in the contact portion of the switch S1, and the oxide film formed at the contact portion is removed. It is not essential to switch the switches S1 and S2 from close to open, from open to close, and from close to open. For example, the switches S1 and S2 may be switched from close to open or from open to close only once.

TABLE 1

| | Step | | | | | | | |
|---|---|---|---|---|---|---|---|---|
| Switch | S9 | S13-1 | S13-2 | S13-3 | S14-1 | S14-2 | S14-3 | S14-4 |
| S1 | Open | Open | Open | Open | Close | Open | Close | Open |
| S2 | Close | Open | Close | Open | Open | Open | Open | Open |

Next, in step S15, the string controller 102 switches the open/close state of the switches S1 and S2 of the bypass switch unit B″ to restore the connection or bypass state of the storage battery module M″ that is not a target of the bypass control request to the state recorded in the memory in step S3. At this time, the string controller 102 switches the open/close state of the switches S1 and S2 of the bypass switch unit B′ such that the storage battery module M′ that is a target of the bypass control request is in the bypass state. After that, the processing ends.

As described above, the storage battery control device 100 of the present embodiment sets the string current to the first predetermined value by the power converter PC, and sets the connection or bypass state of the plurality of storage battery modules M1 to Mn to the predetermined state by the plurality of bypass switch units B1 to Bn. Accordingly, the total voltage of the storage battery string STR becomes equal to or lower than withstand voltages of the bypass switch units B1 to Bn, and the first condition under which the arc discharge occurs at the contact portions of the switches S1 and S2, which are the mechanical relays, is satisfied. Then, the storage battery control device 100 executes the oxide film removal processing of opening and closing the switches S1 and S2, which are the mechanical relays, in the state in which the first condition is satisfied. Thereafter, the storage battery control device 100 executes the bypass control of the storage battery module M′ that is a target of the bypass control request. Further, the storage battery control device 100 restores the connected state or the bypass state of the storage battery module M″ that is not a target of the bypass control request to an original state.

That is, the storage battery control device 100 of the present embodiment reduces the string current to the first predetermined value by the power converter PC, and then executes the bypass control of the storage battery module M′ that is the target of the bypass control request. Accordingly, it is possible to prevent a large fluctuation exceeding the allowable range from occurring in the input and output power of the electricity storage system 1 during the execution of the bypass control.

Further, the storage battery control device 100 of the present embodiment sets the string current to the first predetermined value at which the arc discharge occurs in the contact portions of the switches S1 and S2 by the power converter PC, and then switches open/close of the predetermined switches S1 and S2. Accordingly, the oxide film formed at the contact portions of the switches S1 and S2, which are the mechanical relays, can be removed.

Further, the storage battery control device 100 of the present embodiment sets the connection or bypass state of the storage battery modules M1 to Mn during the execution of the oxide film removal processing such that the total voltage of the storage battery string STR is equal to or lower than the withstand voltages of the bypass switch units B1 to Bn. Accordingly, even when the withstand voltages of the protection circuit 16 and the switches S1 and S2 are set to be lower than the total voltage of the storage battery string STR, it is possible to prevent an overvoltage from being applied to the protection circuit 16 and the switches S1 and S2 of the bypass switch units B1 to Bn that are targets of the oxide film removal processing when the oxide film removal processing is executed. Therefore, a low-cost Zener diode or a mechanical relay having a low withstand voltage can be used for the protection circuit 16 or the switches S1 and S2 of the bypass switch units B1 to Bn, and the cost of the bypass switch units B1 to Bn can be reduced.

The storage battery control device 100 of the present embodiment reduces the string current to the second predetermined value by the power converter PC to satisfy the second condition. Thereafter, in a state where the second condition is satisfied, the storage battery control device 100 sets the connection or bypass state of the storage battery modules M1 to Mn by the plurality of bypass switch units B1 to Bn to a “predetermined state” in consideration of the withstand voltages of the bypass switch units B1 to Bn and the total voltage of the storage battery string STR described above.

Here, the second predetermined value is lower than the first predetermined value, and is set to be low enough to suppress the fluctuation of the input and output power of the electricity storage system 1 within the allowable range when the bypass control of the storage battery modules M1 to Mn by the bypass switch units B1 to Bn is executed. Accordingly, when the connection or bypass state of the storage battery modules M1 to Mn is switched to the “predetermined state” by the bypass switch units B1 to Bn in the state in which the second condition is satisfied, the fluctuation in the input and output power of the electricity storage system 1 can be suppressed within the allowable range.

In the electricity storage system 1 of the present embodiment, the bypass switch units B1 to Bn include the protection circuit 16 that performs the overvoltage protection of the switches S1 and S2, and the storage battery control device 100 sets the total voltage of the storage battery string STR during execution of the oxide film removal processing not to exceed the allowable loss of the protection circuit 16. Accordingly, the withstand voltages of the switches S1 and S2 may be set higher than the Zener voltage of the protection circuit 16, and the withstand voltages of the switches S1 and S2 can be set lower than the total voltage of the storage battery string STR. Therefore, the cost of the switches S1 and S2 can be reduced.

The storage battery control device 100 of the present embodiment gradually and continuously changes the instruction value of the string current when changing the string current to the first predetermined value. Specifically, the storage battery control device 100 repeatedly executes the processing of changing the instruction value of the string current toward the first predetermined value by an amount of change (predetermined amount ΔP2) that is smaller than the difference between the first predetermined value and the current value until the instruction value reaches the first predetermined value. Accordingly, the fluctuation of the input and output power of the electricity storage system 1 when the string current is changed to the first predetermined value can be suppressed within the allowable range.

The storage battery control device 100 of the present embodiment gradually and continuously changes the instruction value of the string current when changing the string current to the second predetermined value. Specifically, the storage battery control device 100 repeatedly executes the processing of changing the instruction value of the string current toward the second predetermined value by an amount of change (predetermined amount ΔP1) that is smaller than the difference between the second predetermined value and the current value until the instruction value reaches the second predetermined value. Accordingly, the fluctuation of the input and output power of the electricity storage system 1 when the string current is changed to the second predetermined value can be suppressed within the allowable range.

The storage battery control device 100 of the present embodiment records the current connection or bypass state of the storage battery modules M1 to Mn in the built-in memory before switching the connection or bypass state of the storage battery modules M1 to Mn at the present time point to the “predetermined state” by the bypass switch units B1 to Bn. After executing the oxide film removal processing, the storage battery control device 100 restores the connection or bypass state of the storage battery modules M1 to Mn to the state recorded in the memory by the bypass switch units B1 to Bn except for the storage battery module M′ that is a target of the bypass control. Accordingly, the oxide films of the switches S1 and S2 can be removed, and the connection or bypass state of the storage battery modules M1 to Mn can be set to a desired state after the oxide film removal processing is executed.

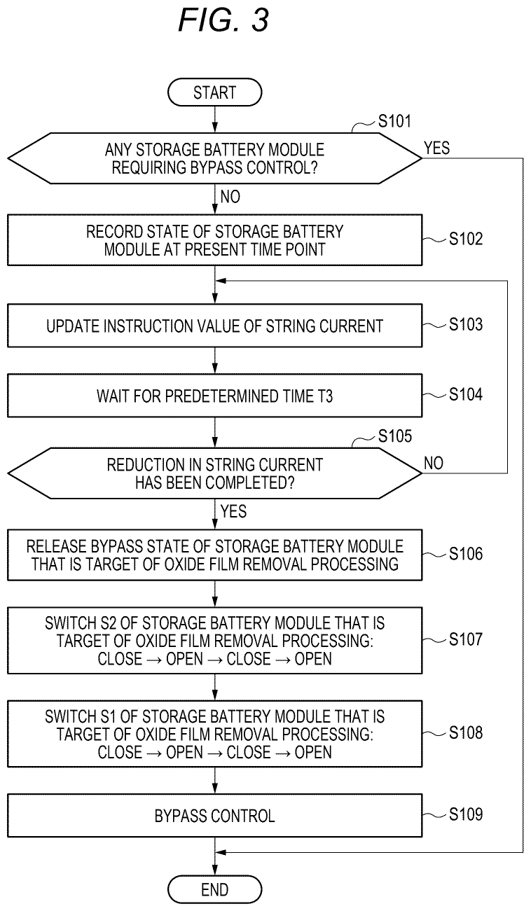

FIG. 3 is a flowchart illustrating oxide film removal processing according to another embodiment of the present disclosure. The processing illustrated in this flowchart is processing for removing oxide films of the switches S1 and S2 of the bypass switch unit B″ corresponding to the storage battery module M″ that is not a target of a bypass control request. First, in step S101, the string controller 102 monitors the storage battery modules M1 to Mn of the storage battery string STR, and determines whether there is a storage battery module M′ requiring the bypass control. If the determination is no in step S101, the processing proceeds to step S102, and if the determination is yes in step S101, the processing ends. When there is the storage battery module M′ requiring the bypass control (YES in step S101), the processing of steps S2 to S15 in FIG. 2 is executed.

In step S102, the connection or bypass state of the storage battery modules M1 to Mn of the storage battery string STR at a present time point is recorded in a built-in memory (not illustrated). Next, the string controller 102 repeatedly executes loop processing of steps S103 to S105 until an instruction value of a string current reaches a third predetermined value (string current reducing processing). Here, in steps S103 to S105, the string controller 102 gradually and continuously reduces the instruction value of the string current from the current value to the third predetermined value by a predetermined amount ΔP3.

First, in step S103, the string controller 102 updates the instruction value of the string current to a value reduced by the predetermined amount ΔP3. The predetermined amount ΔP3 is set to a small amount to meet the purpose of preventing a sudden change in the input and output power of the electricity storage system 1. When a difference between the current value of the string current and the third predetermined value is small, the predetermined amount ΔP3 may be equal to the difference between the current value of the string current and the third predetermined value. On the other hand, when the difference between the current value of the string current and the third predetermined value is relatively large, the predetermined amount ΔP3 may be smaller than the difference between the current value of the string current and the third predetermined value. When the predetermined amount ΔP3 is smaller than the difference between the current value of the string current and the third predetermined value, the string current is repeatedly updated a plurality of times.

The third predetermined value is set to a value that satisfies both the conditions of the first predetermined value and the second predetermined value described above. That is, the third predetermined value is set to a value at which the fluctuation of the input and output power of the entire electricity storage system 1 is suppressed within an allowable range during the bypass control of the storage battery modules M1 to Mn, and the arc discharge occurs in the contact portions of the switches S1 and S2 when the switches S1 and S2 are switched between open and close.

Next, in step S104, the string controller 102 waits for a predetermined time T3 after transmitting the instruction value of the string current to the power converter PC. The predetermined time T3 is set in consideration of time required for the string controller 102 to control the power converter PC and a change rate of the string current.

Next, in step S105, the string controller 102 determines whether the instruction value of the string current has reached the third predetermined value (whether the reduction in the string current has been completed). If the determination is yes in step S105, the processing proceeds to step S106, and if the determination is no in step S105, the processing proceeds to step S103.

Next, in step S106, the string controller 102 switches open/close of the switches S1 and S2 of the bypass switch units B1 to Bn corresponding to the storage battery modules M1 to Mn such that the storage battery modules M1 to Mn that are targets of the oxide film removal processing are in the connected state.

Next, in steps S107 and S108, the string controller 102 executes the oxide film removal processing. First, in step S107, the string controller 102 switches the switch S2 from close to open in a state in which the string current of the third predetermined value flows through each of the switches S2 of the bypass switch units B1 to Bn that are targets of the oxide film removal processing (S107-1 in Table 2 below). Then, the string controller 102 switches the switch S2 from open to close (S107-2 in Table 2 below) and then from close to open (S107-3 in Table 2 below). Accordingly, the arc discharge occurs in the contact portion of the switch S2, and the oxide film formed at the contact portion is removed.

Next, in step S108, the string controller 102 switches each of the switches S1 of the bypass switch units B1 to Bn that are targets of the oxide film removal processing from open to close, and causes the string current of the third predetermined value to flow through the switch S1 (S108-1 in Table 2 below). Then, the string controller 102 switches the switch S1 from close to open (S108-2 in Table 2 below), then from open to close (S108-3 in Table 2 below), and further from close to open (S108-4 in Table 2 below). Accordingly, the arc discharge occurs in the contact portion of the switch S1, and the oxide film formed at the contact portion is removed.

TABLE 2

| | Step | | | | | | | |
|---|---|---|---|---|---|---|---|---|
| Switch | S106 | S107-1 | S107-2 | S107-3 | S108-1 | S108-2 | S108-3 | S108-4 |
| S1 | Open | Open | Open | Open | Close | Open | Close | Open |
| S2 | Close | Open | Close | Open | Open | Open | Open | Open |

Next, in step S109, the string controller 102 switches open/close of the switches S1 and S2 of the bypass switch units B1 to Bn such that the connection or bypass state of the storage battery modules M1 to Mn is restored to the state recorded in the memory in step S102. After that, the processing ends.

As described above, in the processing of the present embodiment, after the string current is reduced to the third predetermined value by the power converter PC, the bypass control of the storage battery modules M1 to Mn that are not targets of the oxide film removal processing is executed. Accordingly, it is possible to prevent a large fluctuation exceeding the allowable range from occurring in the input and output power of the electricity storage system 1 during the execution of the bypass control.

In the processing of the present embodiment, the power converter PC sets the string current to the third predetermined value at which the arc discharge occurs in the contact portions of the switches S1 and S2, and switches open/close of the predetermined switches S1 and S2. Accordingly, the oxide film formed at the contact portions of the switches S1 and S2, which are the mechanical relays, can be removed.

Further, in the processing of the present embodiment, even when withstand voltages of the protection circuit 16 and the switches S1 and S2 are set to be lower than the total voltage of the storage battery string STR, it is possible to prevent an overvoltage from being applied to the protection circuit 16 and the switches S1 and S2 of the bypass switch units B1 to Bn that are targets of the oxide film removal processing when the oxide film removal processing is executed. Therefore, a low-cost Zener diode or a mechanical relay having a low withstand voltage can be used for the protection circuit 16 or the switches S1 and S2 of the bypass switch units B1 to Bn, and the cost of the bypass switch units B1 to Bn can be reduced.

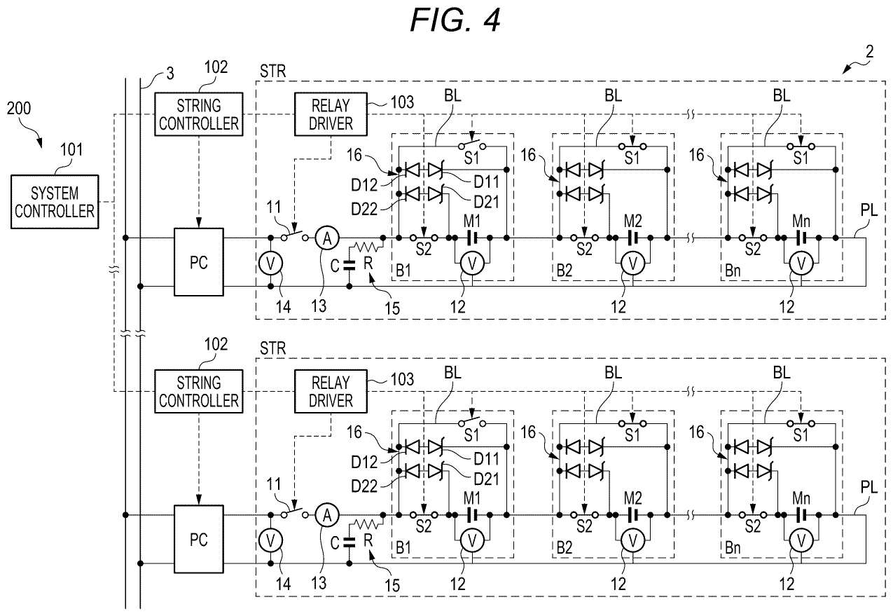

FIG. 4 is a circuit diagram schematically illustrating an electricity storage system 2 according to another embodiment of the present disclosure. The same components as those of the above-described embodiment are denoted by the same reference numerals, and the description of the above-described embodiment is incorporated.

As illustrated in FIG. 4, in the electricity storage system 2 of the present embodiment, each storage battery string STR includes a string cutoff switch 11 and a CR circuit 15. The string cutoff switch 11 is provided between each power converter PC and the storage battery module M1 at a beginning. The string cutoff switch 11 connects or disconnects the power converter PC and the storage battery module M1 at the beginning. The string cutoff switch 11 is provided for the purpose of preventing charges of a capacitor C to be described later from flowing to the power converter PC. For example, in a case where the above object can be achieved without requiring the string cutoff switch 11, such as a case where the operation of the power converter PC can be stopped and an impedance of the power converter PC can be brought into a relatively high state with respect to the impedance of the storage battery string STR, the string cutoff switch 11 may not be provided.

The CR circuit 15 includes the capacitor C and a resistor R connected in series. One end of the resistor R is connected to the capacitor C, and the other end of the resistor R is connected to the power line PL between the string cutoff switch 11 and the bypass switch unit B1 at the beginning. On the other hand, the capacitor C is connected to the power line PL between the bypass switch unit Bn at the end and the power converter PC.

FIG. 4 illustrates a state before a bypass control of the storage battery module M1 is executed in a case where the storage battery module M1 is the storage battery module M′ that is a target of a bypass control request. In this state, the storage battery module M1 is in the connected state, and in the bypass switch unit B1, the switch S1 is open and the switch S2 is closed. On the other hand, the storage battery modules M2 to Mn are in the bypass state, and in the bypass switch units B2 to Bn, the switches S1 are closed and the switches S2 are open. The string cutoff switch 11 is open.

In this state, a transient current flows from a positive electrode of the storage battery module M1 to the CR circuit 15 via the switch S2 of the bypass switch unit B1, charges the capacitor C, and flows to a negative electrode of the storage battery module M1 via the switches S1 of the bypass switch units B2 to Bn. Here, in the state illustrated in FIG. 4, a maximum value of the transient current flowing through the storage battery module M1, the switch S2 of the bypass switch unit B1, the CR circuit 15, and the like to charge the capacitor C is set to the first predetermined value. The “first predetermined value” is set to a value at which the arc discharge occurs in a contact portion of the switch S2 by the transient current that flows through the storage battery module M1, the switch S2 of the bypass switch unit B1, the CR circuit 15, and the like and charges the capacitor C during the operation of the switch S2, which is a mechanical relay, and an oxide film formed at the contact portion can be removed. The “first predetermined value” is set such that the total voltage of the storage battery string STR does not exceed an allowable loss of the protection circuit 16 when the transient current flows through the storage battery module M1, the switch S2, the CR circuit 15, and the like.

A storage battery control device 200 switches the storage battery module M1 from the connected state illustrated in FIG. 4 to the bypass state in a state in which the capacitor C of the CR circuit 15 is charged. In the state in which the storage battery module M1 is switched to the bypass state, the transient current flows through the capacitor C, the switch S1 of the bypass switch unit B1, and the bypass switch units B2 to Bn. Here, the maximum value of the transient current flowing through the capacitor C, the switch S of the bypass switch unit B1, and the like when the storage battery module M1 is switched to the bypass state is set to a fourth predetermined value. The “fourth predetermined value” is set to a value at which an arc discharge occurs in a contact portion of the switch S1 by a transient current flowing through the capacitor C, the switch S1, and the like during the operation of the switch S1, which is a mechanical relay, and an oxide film formed at the contact portion can be removed. The “fourth predetermined value” is set such that the total voltage of the storage battery string STR does not exceed the allowable loss of the protection circuit 16 when the transient current flows through the capacitor C, the switch S1, and the like.

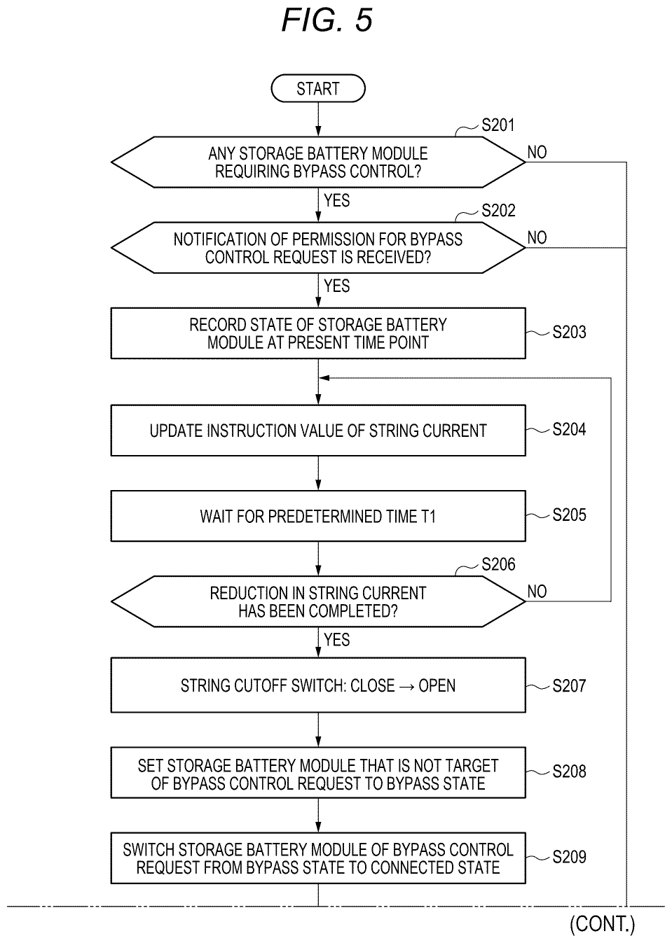

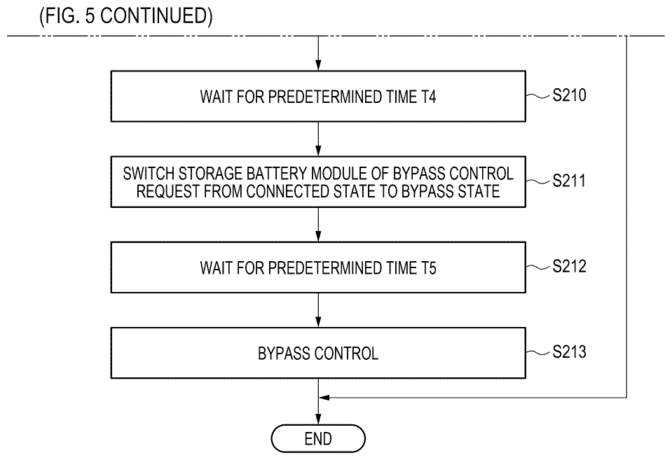

FIG. 5 is a flowchart illustrating processing in which the storage battery control device 200 illustrated in FIG. 4 switches the storage battery module M′ that is a target of the bypass control request from the connected state to the bypass state. The processing will be described by taking a case where the storage battery module M′ that is a target of the bypass control request is the storage battery module M1 as an example, but the same processing may be executed when the other storage battery modules M2 to Mn are the storage battery modules M′ that are targets of the bypass control request. Further, it is not essential to execute the oxide film removal processing on the storage battery module M′ that is a target of the bypass control request, and the storage battery modules M1 to Mn for executing the oxide film removal processing and a timing for executing the oxide film removal processing may be appropriately set.

First, in step S201, the string controller 102 monitors the storage battery modules M1 to Mn of the storage battery string STR, and determines whether there is a storage battery module M′ requiring the bypass control. If the determination is yes in step S201, the processing proceeds to step S202, and if the determination is no in step S201, the processing ends.

In step S202, the string controller 102 transmits the bypass control request to the system controller 101, and determines whether a notification of permission for the bypass control request is received from the system controller 101. If the determination is yes in step S202, the processing proceeds to step S203, and if the determination is no in step S202, the processing ends.

In step S203, the string controller 102 records the connection or bypass state of the storage battery modules M1 to Mn of the storage battery string STR at the present time point in a built-in memory (not illustrated). Next, the string controller 102 repeatedly executes loop processing of steps S204 to S206 until an instruction value of a string current reaches a second predetermined value (string current reducing processing). The “second predetermined value” is a value lower than the “first predetermined value” and the “fourth predetermined value” described above, and is set to a low value to the extent that the fluctuation of the input and output power of the entire electricity storage system 1 is suppressed within an allowable range during the bypass control of the storage battery string STR. In the present embodiment, the second predetermined value is 0. Here, in steps S204 to S206, the string controller 102 gradually and continuously reduces the instruction value of the string current from the current value to the second predetermined value by the predetermined amount ΔP1.

First, in step S204, the string controller 102 updates the instruction value of the string current to a value reduced by the predetermined amount ΔP1. The predetermined amount ΔP1 is set to a small amount to meet the purpose of preventing a sudden change in the input and output power of the electricity storage system 1. When a difference between the current value of the string current and the second predetermined value is small, the predetermined amount ΔP1 may be equal to the difference between the current value of the string current and the second predetermined value. On the other hand, when the difference between the current value of the string current and the second predetermined value is relatively large, the predetermined amount ΔP1 may be smaller than the difference between the current value of the string current and the second predetermined value. When the predetermined amount ΔP1 is smaller than the difference between the current value of the string current and the second predetermined value, the string current is repeatedly updated a plurality of times.

Next, in step S205, the string controller 102 waits for a predetermined time T1 after transmitting the instruction value of the string current to the power converter PC. The predetermined time T1 is set in consideration of time required for the string controller 102 to control the power converter PC and a change rate of the string current.

Next, in step S206, the string controller 102 determines whether the string current has reached the second predetermined value (whether the reduction in the string current has been completed). If the determination is yes in step S206, the processing proceeds to step S207, and if the determination is no in step S206, the processing proceeds to step S204.

In step S207, the string controller 102 opens (disconnected state) the string cutoff switch 11. When the string current is sufficiently reduced by the power converter PC, it is not essential to cut off the storage battery string STR by the string cutoff switch 11.

Next, in step S208, the string controller 102 sets the storage battery modules M2 to Mn that are not targets of the bypass control request to the bypass state (see FIG. 4). Next, in step S209, the string controller 102 sets the storage battery module M1 that is a target of the bypass control request to a connected state. Specifically, the switch S1 of the bypass switch unit B1 is open, and then the switch S2 of the bypass switch unit B1 is closed. At this time, the transient current flows through the storage battery module M1, the switch S2 of the bypass switch unit B1, the CR circuit 15, and the like, the arc discharge occurs in the contact portion of the switch S2 of the bypass switch unit B1, and the oxide film formed at the contact portion is removed.

Next, in step S210, the string controller 102 waits for a predetermined time T4 from step S209. The predetermined time T4 is set in consideration of time required for charging the capacitor C. Here, the time required for charging the capacitor C corresponds to the time until the CR circuit 15 gets out of the transient state and reaches the steady state, and is obtained based on a time constant τ (=C×R).

Next, in step S211, the string controller 102 switches the storage battery module M1 that is a target of the bypass control request from the connected state to the bypass state. Specifically, the switch S2 of the bypass switch unit B1 is open, and then the switch S1 of the bypass switch unit B1 is closed. At this time, the transient current flows through the capacitor C, the switch S1 of the bypass switch unit B1, and the like, the arc discharge occurs in the contact portion of the switch S1 of the bypass switch unit B1, and the oxide film formed at the contact portion is removed.

Next, in step S212, the string controller 102 waits for a predetermined time T5 from step S211. The predetermined time T5 is set in consideration of time required for discharging the capacitor C. Here, the time required for discharging the capacitor C is obtained based on the time constant τ (=C×R).

Next, in step S213, the string controller 102 switches the open/close state of the switches S1 and S2 of the bypass switch units B2 to Bn to restore the connection or bypass state of the storage battery modules M2 to Mn that are not targets of the bypass control request to the state recorded in the memory in step S203. After that, the processing ends.

As described above, in the electricity storage system 2 of the present embodiment, the storage battery string STR includes the CR circuit 15 connected between the switch S2 corresponding to the storage battery module M1 at the beginning and the power converter PC and between the storage battery module Mn at the end and the power converter PC. In the electricity storage system 2, the storage battery control device 200 executes the following first oxide film removal processing.

### (First Oxide Film Removal Processing)

All the storage battery modules M1 to Mn are set to the bypass state by the plurality of bypass switch units B1 to Bn, and then any one of the storage battery modules M1 is switched to the connected state by any one of the bypass switch units B1.

Here, the maximum value of the transient current flowing through the storage battery module M1 in the connected state, the switch S2 of the bypass switch unit B1, the CR circuit 15, and the like is set such that the total voltage of the storage battery string STR is equal to or less than the withstand voltages of the bypass switch units B1 to Bn and the first condition under which the arc discharge occurs in the switch S2 of the bypass switch unit B1 is satisfied when the storage battery control device 200 executes the first oxide film removal processing. Accordingly, during the execution of the first oxide film removal processing, the arc discharge occurs in the switch S2 of the bypass switch unit B1 by the transient current flowing through any one of the storage battery modules M1, the switch S2 of the bypass switch unit B1, the CR circuit 15, and the like, and the oxide film formed on the switch S2 can be removed.

The storage battery control device 200 executes the following second oxide film removal processing.

### (Second Oxide Film Removal Processing)

After the execution of the first oxide film removal processing, any one of the bypass switch units B1 switches the storage battery module M1 in the connected state to the bypass state.

Here, the maximum value of the transient current flowing through the CR circuit 15, the switch S1 of the bypass switch unit B1, and the like is set such that the total voltage of the storage battery string STR is equal to or less than the withstand voltages of the bypass switch units B1 to Bn and the second condition under which arc discharge occurs in the switch S1 of the bypass switch unit B1 is satisfied when the storage battery control device 200 executes the second oxide film removal processing. Accordingly, during the execution of the second oxide film removal processing, the arc discharge occurs in the switch S1 of the bypass switch unit B1 by the transient current flowing through the CR circuit 15, the switch S1 of the bypass switch unit B1, and the like, and the oxide film formed on the switch S1 can be removed.

Although the present disclosure has been described above based on the above embodiment, the present disclosure is not limited to the above embodiment. Modifications may be made without departing from the gist of the present disclosure, or publicly known or well-known techniques may be appropriately combined.

For example, in the above-described embodiment, the switches S1 and S2 are mechanical relays, but at least one of the switches S1 and S2 may be a semiconductor switch. In this case, the oxide film removal processing may be performed on only one of the switches S1 and S2, which are mechanical relays.

The timing of executing the oxide film removal processing and the storage battery modules M1 to Mn that are targets of the oxide film removal processing may be appropriately set. Further, it is not essential to provide the protection circuit 16 in the bypass switch units B1 to Bn, and when the protection circuit 16 is not provided, the total voltage of the storage battery string STR during the execution of the oxide film removal processing may be set to be equal to or lower than the withstand voltage of the switches S1 and S2, which are mechanical relays.

In the above-described embodiment, the instruction value of the string current is gradually and continuously changed to the target value over time by the predetermined amounts ΔP1, ΔP2, and ΔP3. However, for example, when the influence of the change in the string current on the input and output power of the electricity storage system 1 is slight, the instruction value of the string current may be changed all at once.

Further, in the above-described embodiment, the CR circuit 15 is exemplified as a power storage and current suppression circuit, but the power storage and current suppression circuit only needs to have a function of storing charges and the function of suppressing a current, and for example, a constant current diode or a current control circuit may be provided instead of the resistor R.

Although various embodiments have been described above, it is needless to say that the present disclosure is not limited to these examples. It is apparent that those skilled in the art can come up with various modifications or corrections within the scope of the claims, and it is understood that the modifications or corrections naturally fall within the technical scope of the present disclosure. In addition, components described in the above embodiments may be combined freely without departing from the spirit of the invention.

The present application is based on a Japanese patent application (No. 2023-38380) filed on Mar. 13, 2023, the contents of which are incorporated herein by reference.

What is claimed is:

1. A storage battery control device that controls an electricity storage system,
the electricity storage system includes
a storage battery string, and
a power converter that converts input and output power of the storage battery string,
the storage battery string includes
a plurality of storage batteries connected in series, and
a plurality of bypass circuits each including a first switch that is provided between the storage batteries adjacent to each other, a bypass line that bypasses the first switch and the storage battery, and a second switch that is provided on the bypass line, and switching the storage battery between a connected state and a bypass state, wherein
at least one of the first switch and the second switch is a mechanical relay,
a current of the storage battery string is set to a first predetermined value by the power converter, and a connection or bypass state of the plurality of storage batteries is set to a predetermined state by the plurality of bypass circuits such that a total voltage of the storage battery string is equal to or less than a withstand voltage of the bypass circuit and a first condition under which arc discharge occurs in the at least one of the first switch and the second switch, which are mechanical relays, is satisfied, and
Oxide film removal processing is executed to open and close at least one of the first switch and the second switch, which are mechanical relays in a state that the first condition is satisfied.

2. The storage battery control device according to claim 1, wherein
the current of the storage battery string is reduced by the power converter such that a second condition under which the current of the storage battery string is a second predetermined value lower than the first predetermined value is satisfied,
the connection or bypass state of the plurality of storage batteries is set to the predetermined state by the plurality of bypass circuits in a state that the second condition is satisfied, and
the current of the storage battery string is increased to the first predetermined value by the power converter and the first condition is satisfied in the state that the connection or bypass state of the plurality of storage batteries is set to the predetermined state.

3. The storage battery control device according to claim 1, wherein
the bypass circuit includes a protection circuit that performs overvoltage protection of the at least one of the first switch and the second switch, and
a withstand voltage of the bypass circuit is equal to or higher than a Zener voltage of the protection circuit.

4. The storage battery control device according to claim 1, wherein
when the current of the storage battery string is changed to the first predetermined value, processing of changing an instruction value of the current of the storage battery string toward the first predetermined value by an amount of change smaller than a difference between the first predetermined value and a current value is repeatedly executed until the instruction value reaches the first predetermined value.

5. The storage battery control device according to claim 2, wherein
when the current of the storage battery string is changed to the second predetermined value, processing of changing an instruction value of the current of the storage battery string toward the second predetermined value by an amount of change smaller than a difference between the second predetermined value and a current value is repeatedly executed until the instruction value reaches the second predetermined value.

6. The storage battery control device according to claim 1, wherein
before the connection or bypass state of the plurality of storage batteries is set to the predetermined state by the plurality of bypass circuits, the connection or bypass state of the plurality of storage batteries at a present time point is recorded in a storage unit, and
after the oxide film removal processing is executed, the connection or bypass state of the plurality of storage batteries is restored to the state recorded in the storage unit by the plurality of bypass circuits except for the storage batteries that need to be switched between the connected state and the bypass state.

7. An electricity storage system comprising:
a storage battery string;
a power converter configured to convert input and output power of the storage battery string; and
a storage battery control device configured to control the storage battery string and the power converter, wherein
the storage battery string includes
a plurality of storage batteries connected in series, and
a plurality of bypass circuits each including a first switch that is provided between the storage batteries adjacent to each other, a bypass line that bypasses the first switch and the storage battery, and a second switch that is provided on the bypass line, and switching the storage battery between a connected state and a bypass state,
at least one of the first switch and the second switch is a mechanical relay, and
the storage battery control device
sets a current of the storage battery string to a first predetermined value by the power converter and sets a connection or bypass state of the plurality of storage batteries to a predetermined state by the plurality of bypass circuits such that a total voltage of the storage battery string is equal to or less than a withstand voltage of the bypass circuit and a first condition under which arc discharge occurs in the at least one of the first switch and the second switch, which are mechanical relays, is satisfied, and
executes oxide film removal processing to open and close the at least one of the first switch and the second switch, which are mechanical relays, in a state that the first condition is satisfied.

8. An electricity storage system comprising:
a storage battery string;
a power converter configured to convert input and output power of the storage battery string; and
a storage battery control device configured to control the storage battery string and the power converter, wherein
the storage battery string includes
a plurality of storage batteries connected in series,
a plurality of bypass circuits each including a first switch that is a mechanical relay and is provided between the storage batteries adjacent to each other, a bypass line that bypasses the first switch and the storage battery, and a second switch that is provided on the bypass line, and switching the storage battery between a connected state and a bypass state, and
a power storage and current suppression circuit connected between the first switch corresponding to the storage battery at a beginning and the power converter, and between the storage battery at an end and the power converter, and including a power storage unit and a current suppression unit, and
the storage battery control device
executes first oxide film removal processing of switching any one of the storage batteries to a connected state by any one of the bypass circuits after all the storage batteries are set to the bypass state by the plurality of bypass circuits, and
sets a maximum value of a transient current flowing through the storage battery in the connected state, the first switch, and the power storage and current suppression circuit such that a total voltage of the storage battery string is equal to or less than a withstand voltage of the bypass circuit and a first condition under which arc discharge occurs in the first switch is satisfied when the storage battery control device executes the first oxide film removal processing.

9. The electricity storage system according to claim 8, wherein
the second switch is a mechanical relay,
the storage battery control device
executes second oxide film removal processing of switching the storage battery in the connected state to the bypass state by any one of the bypass circuits after executing the first oxide film removal processing, and
a maximum value of a transient current flowing through the power storage and current suppression circuit and the second switch is set such that a total voltage of the storage battery string is equal to or lower than a withstand voltage of the bypass circuit and a second condition under which arc discharge occurs in the second switch is satisfied when the storage battery control device executes the second oxide film removal processing.
